(19) United States
(12) Patent Application Publication
(10) Pub. No.: US 2011/0218889 A1
(43) Pub. Date: Sep. 8, 2011

(54) Retail Display System With Integrated Security and Inventory Management

(75) Inventors: Todd C. Westberg, Cherry Valley, IL (US); Joerg Niederhuefner, Altenmedingen (DE)

(73) Assignee: Southern Imperial, Inc., Rockford, IL (US)

(21) Appl. No.: 12/718,737

(22) Filed: Mar. 5, 2010

(51) Int. Cl. G06Q 10/00

(52) U.S. Cl. 705/28

(57) ABSTRACT

A retail display system with integrated inventory management and security is provided. The retail display system is operably connected to a control module operable to detect the addition or removal of inventory from the retail display system. The control module may be configured to manually or automatically associate a quantity of merchandise with a value of a sensed parameter, such that control module recognizes that the occurrence of the sensed parameter corresponds to the addition or subtraction of merchandise.

### FIELD OF THE INVENTION

This invention generally relates to retail display systems, and more particularly to retail display systems incorporating active and passive loss prevention and inventory management measures.

### BACKGROUND OF THE INVENTION

Retail theft is an ongoing problem in retail environments. As retail theft increases, retail profits decrease. As a result, retailers often times must increase the price of merchandise to maintain profitability. Accordingly, retail theft affects retailers and consumers alike. Various loss prevention measures, including enhanced security and inventory monitoring have been employed in various retail environments and retail display systems to reduce retail theft.

One type of retail display system, a pusher system, has been used for some time in various retail markets for facing products, i.e. biasing the products towards the consumer in a neat and organized manner. It is generally accepted that facing products can increase retail sales, and as a result, many retail stores now incorporate pusher systems for various merchandise. A typical pusher system uses a pusher to bias products forward. The pusher is typically biased forward by a biasing element such as a coil spring, connected to a leading edge of a shelf or other structure. Retail products are contained between the leading edge of the shelf or other structure and the pusher so that as the pusher is biased forward, so too are the retail products. Dividers are often used to separate rows of merchandise contained in multiple pusher systems arranged in parallel to one another. As a leading item of merchandise is removed, the pusher biases the row forward, so that the next item is now the leading item.

Another type of retail display system, a gravity fed system, has also been used for some time for facing products. A gravity fed system is similar to a pusher system with the exception that it relies upon gravity to bias merchandise forward as opposed to a pusher. Gravity feed systems are typically located on an angled shelf, and contain merchandise therein in a line or row. As a leading item of merchandise is removed, gravity biases the remaining products forward, so that the next item of merchandise is now the leading item.

Pusher and gravity feed systems, i.e. self facing merchandisers, like many other retail display systems, are subject to retail theft attempts. Indeed, these systems do not ordinarily contain additional security devices or measures, and as a result, products can simply be removed from the systems in a retail theft scenario. This problem is particularly acute where higher value products are contained by the system. In response, many retailers have incorporated additional external security measures.

One such security measure used in the past has been to lock the entire system(s) in a case. When a consumer wishes to remove an item from the system, a store employee must open the case and remove the item for the consumer. Unfortunately, it has been shown that such a configuration can reduce retail sales. Consumers can grow impatient waiting for a store employee to unlock the case when an employee is not readily available. Often times, the consumer will abandon their previously formed intention to purchase the product within the case, as the consumer simply grows tired of waiting.

Additionally, it is generally accepted that monitoring inventory levels of retail merchandise carried by pusher and gravity feed systems plays an important role in loss prevention. Unfortunately, retail merchandise is typically inventoried by manually counting the number of items of retail merchandise carried within the self facing retail display system. Manually inventorying merchandise can increase labor costs, and is subject to error.

There exists, therefore, a need in the art for a retail display system that provides additional loss prevention measures without sacrificing consumer access and the sales generated thereby, unlike the systems described above. The invention provides such a pusher system. These and other advantages of the invention, as well as additional inventive features, will be apparent from the description of the invention provided herein.

### BRIEF SUMMARY OF THE INVENTION

The present invention has several aspects that may be claimed and stand as patentable independently and individually or in combination with other aspects. Some aspects are summarized below, while others may be developed in the remainder of the disclosure.

In one aspect, embodiments of the invention provide a retail display system including an alarm sounding pusher system that provides an audible tone upon the movement of a pusher. An embodiment of this aspect of the invention includes a pusher movable for facing retail merchandise and a tone generation module in electrical communication with the pusher. The tone generation module is operable to provide an audible tone upon removal of one or more items of merchandise from the retail display system.

In a subsidiary embodiment, the tone generation module is in electrical communication with the pusher. A movement of the pusher causes a change of state in an electrical circuit formed between the pusher and the tone generation module. The tone generation module is operable to provide the audible tone upon the change of state.

In another aspect, embodiments of the invention provide a retail display system that includes a self facing merchandiser that provides an audible notification upon the removal of merchandise therefrom. The retail merchandiser is configured to self face retail merchandise toward a front of a shelf. A tone generation module is operable to provide an audible tone upon removal of one or more items of merchandise from the self facing merchandiser and generally any time one or more items of merchandise is removed.

In a subsidiary embodiment, the tone generation module is connected to a sensor that is adapted to sense withdrawal of a leading one of the items of merchandise on the shelf. The self facing merchandiser can be a pusher that is movable for facing retail merchandise. The tone generation module is in electrical communication with the pusher via a sensor and is operable to provide an audible tone upon removal of one or more items of merchandise from the retail display system due to movement of the pusher.

In another aspect, embodiments of the invention provide a retail display system system that intermittently opens and closes an electrical circuit. An embodiment of a pusher system according to this aspect includes a pusher having a first contact and a track providing a second contact. The pusher is slidable along the track. The first and second contacts intermittently align and misalign as the pusher slides along the track. A tone generation module is in communication with at least one of the first and second contacts and is operable to provide an audible tone upon the intermittent alignment and misalignment of the first and second contacts.

In a subsidiary embodiment, the first contact extends from a bottom of the pusher and the track has an opening configured to receive the first contact. The second contact is carried within a pocket of the track. The first contact extends through the opening and into the pocket to contact the second contact. The second contact can be a contact board that has a first and a second contact strip carried by a non-conductive base of the contact board. The first contact strip can be a continuous strip of conductive material and the second contact strip can also be a strip of conductive material. The second contact strip can have a base portion and a plurality of spaced apart extensions with a portion of the non-conductive base disposed between adjacent spaced apart extensions of the plurality of extensions.

In yet another aspect, an embodiment of the invention provides a method for monitoring levels of retail merchandise contained in a self facing retail display system. The method according to this embodiment includes sensing a parameter associated with a movement of the retail merchandise using a sensor and determining a repeating value of the parameter for a select retail product based upon said sensing during placement or removal of one or more individual units of retail merchandise from the self facing retail display system.

In yet another aspect, an embodiment of the invention provides a method for monitoring levels of retail merchandise contained in a self facing retail display system by manually teaching a control module a parameter that corresponds to a predetermined addition or removal of retail merchandise. The method according to this aspect includes manually initiating a retail merchandise learning mode of a control module and changing an amount of retail merchandise carried by the retail display system by either adding or subtracting one or more individual units of retail merchandise. The method further comprises the step of sensing a parameter associated with the change of the amount of retail merchandise using a sensor.

In yet another aspect, an embodiment of the invention provides a method for monitoring levels of retail merchandise contained in a self facing retail display system using a self-learning control module. The method according to this aspect includes sensing a parameter associated with the addition or removal of one or more selected items of retail merchandise using a sensor and automatically associating a quantity of merchandise with a value of the parameter based on said sensing using a control module.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of an alarm sounding retail display system in accordance with the teachings of the present invention;

FIG. 2 is a perspective exploded view of the embodiment of FIG. 1;

FIG. 3 is a front view of a pusher, contact board, and a track of the embodiment of FIG. 1;

FIG. 4 is a partial side sectional view of the pusher and the track of FIG. 3;

FIG. 5 is a bottom view of a contact structure of the pusher of FIG. 3;

FIG. 6 is back perspective view of the pusher, contact board, and track of FIG. 3;

FIGS. 7A-7B are sectional views of various positions of a first and second contact member carried by the contact structure of FIG. 5 relative to the contact board of FIG. 3;

FIG. 8 is a perspective view of an end cap of the alarm sounding pusher of FIG. 1;

FIG. 9 is a partial side cross sectional view of the end cap, track, and contact board of FIG. 2;

FIGS. 10-13 are schematic representations of various configurations of a tone generation module of the alarm sounding retail display system of FIG. 1;

FIG. 14 is a partial side cross sectional view of an alternative embodiment of an alarm sounding retail display system of FIG. 1;

FIG. 15 is perspective view of a further embodiment of an alarm sounding retail display system;

FIG. 16 is a perspective exploded view of the embodiment of FIG. 15;

FIG. 17 is a back partial cross sectional view of a pusher, contact board, and track of the embodiment of FIG. 15;

FIG. 18 is a side partial cross sectional view of a pusher, contact board, and track of the embodiment of FIG. 15;

FIG. 19 is a back perspective view of the embodiment of FIG. 15 with the contact board partially exposed;

FIG. 20 is a side view of an exemplary embodiment of a retail display system in accordance with the teachings of the present invention;

FIG. 21 is a front view of the retail display system of FIG. 20;

FIG. 22 is a side view of a further embodiment of the retail display system of FIG. 20;

FIG. 23 is a schematic representation of multiple retail display systems interconnected to a control module;

FIG. 24 is a graphical representation of a distribution of a sensed parameter of one of the retail display systems of FIG. 23;

FIG. 25 is a flow chart depicting one embodiment of control logic of the control module of FIG. 23; and

FIG. 26 is a flow chart depicting another embodiment of control logic of the control module of FIG. 23.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, embodiments of a retail display system having integrated inventory management and security are provided. As will be explained in greater detail by the following, the retail display system may employ active or passive inventory management and security measures, or a combination of both.

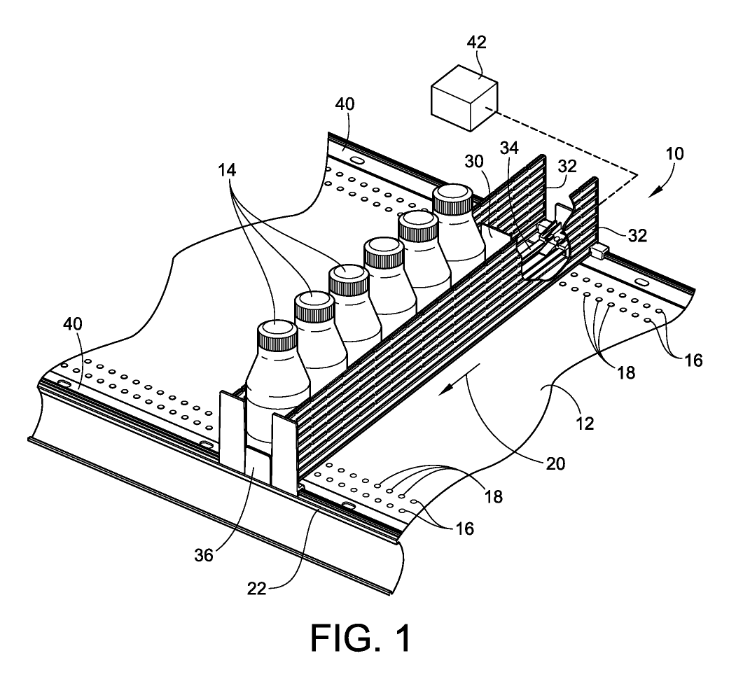

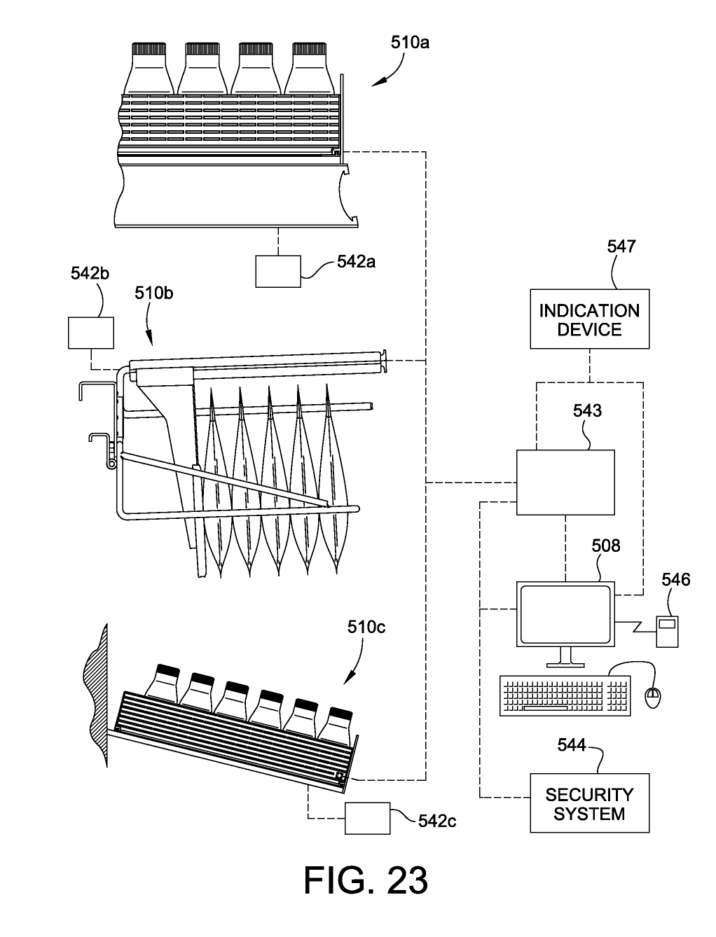

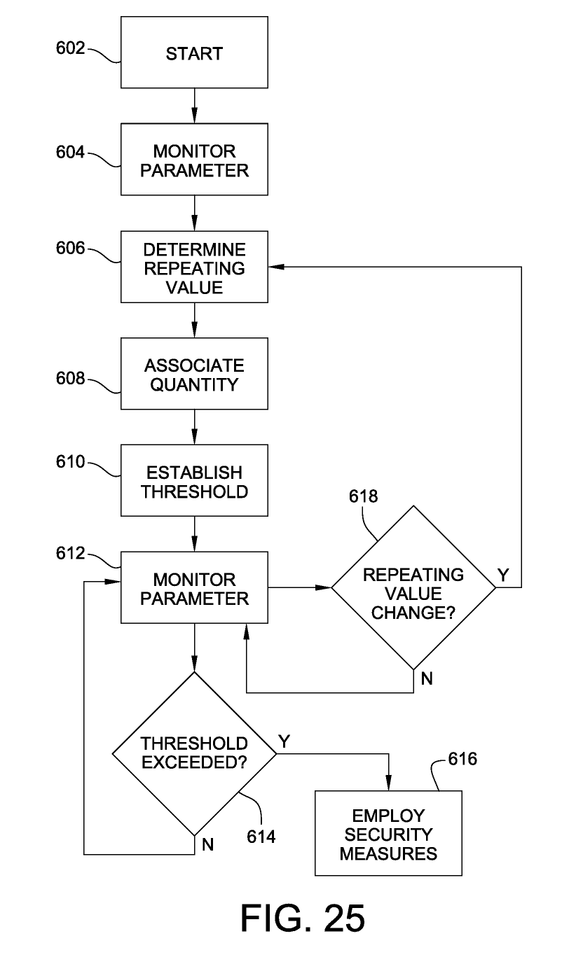

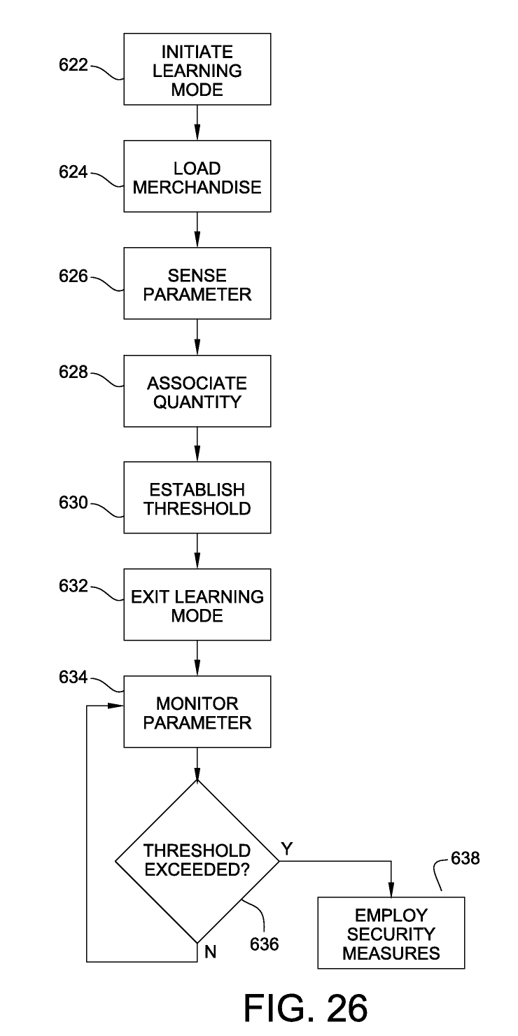

FIGS. 1-22 generally illustrate embodiments of a passive, i.e. “dummy” system, where an impression of enhanced security is provided using an audible tone generated upon movement of retail merchandise carried by the retail display system. FIGS. 23-26 generally illustrate embodiments of an active system, where a control module provides the ability to monitor inventory levels, detect and quantify consumer behavior relative to particular merchandise, detect instances of removal of abnormal amounts of merchandise from the retail display system, alert security in the event of a potential retail theft, etc. While the passive and active systems are generally discussed in turn, beginning with embodiments of the passive system, it is recognized that a network of active and passive systems can be employed together or independently. One advantage of employing active and passive systems together is the ability to provide a more broad range of inventory management and security that is specific to differing types of retail merchandise.

Referring now to FIG. 1, a retail display system embodied as an alarm sounding pusher system 10 is illustrated in a typical retail environment. The alarm sounding pusher system 10 is situated on a retail shelf 12, and carries retail merchandise 14 therein. As is generally known in the art, the shelf 12 incorporates rows 16 of apertures 18 for mounting the pusher system 10 thereto. The merchandise 14 is biased toward a front edge 22 of the shelf 12 in a facing direction 20. As a front most item of retail merchandise 14 is removed, the next adjacent item of retail merchandise 14 is biased forward by the pusher system 10.

The alarm sounding pusher system 10 also includes a tone generation module 42. As will be discussed in greater detail below, the tone generation module 42 is operable to provide an audible tone upon a movement of the pusher 30 along the shelf 12. It will be recognized that the audible tone provided by the tone generation module 42 can discourage attempts of retail theft from the alarm sounding pusher system 10 because it presents an indication of potential additional security systems associated with the alarm sounding pusher system 10. The audible tone provided by the tone generation module 42 can also deter attempts of retail theft from the alarm sounding pusher system 10 because nearby employees hearing the audible tone can monitor the alarm sounding pusher system 10 for any theft activity. The tone generation module 42 may be mounted directly to the shelf 12, or otherwise mounted in proximity to the alarm sounding pusher system 10.

It will be recognized from the following disclosure that the advantages of the tone generation module 42 discussed above are not limited to the illustrated alarm sounding pusher system 10 of FIG. 1. To the contrary, the tone generation module 42 can provide the above advantages in various types of pusher systems and is not limited to the illustrated embodiment of FIG. 1. Indeed, while such an exemplary retail embodiment is provided, it will be recognized from the following that embodiments of the invention may be implemented in various other retail environments.

Additionally, and as will be described in greater detail by the following, the retail display system as described herein can also provide inventory management and enhanced security through the use of a control module. The control module can be automatically or manually programmed to recognize and associate a sensed parameter of the retail display system with a quantity of merchandise. Once associated, the control module can provide numerous additional loss prevention functions. For example, the control module can determine a total quantity of merchandise carried by the retail display system or systems. The control module can also provide an indication of the amount of retail merchandise presently carried by the retail display system, and alert store personnel of low levels of inventory.

The control module can also recognize when an amount of merchandise has been removed that is outside of the normal consumer characteristics for a given type of merchandise, thereby potentially evincing a retail theft incident. Once recognized, the control module can perform numerous other functions. For example, the control module can provide an indication that a threshold amount of retail merchandise has been removed. As another example, the control module can alert a security system, e.g. a security camera, that the threshold amount of retail merchandise has been removed.

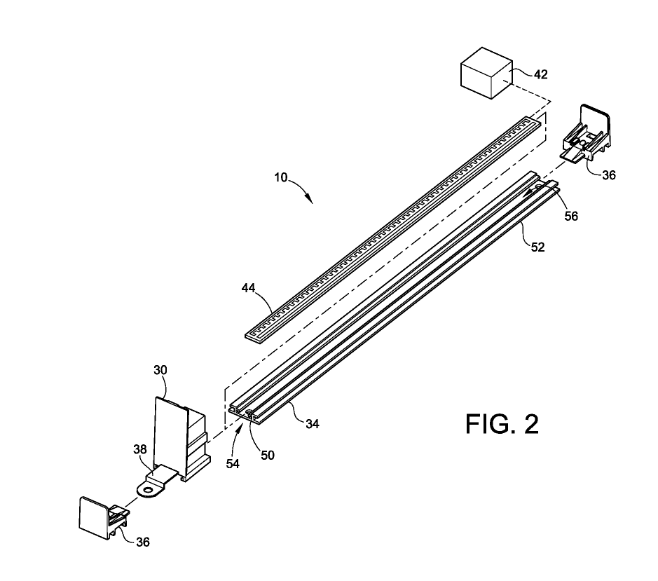

In the illustrated embodiment of FIG. 1, the alarm sounding pusher 10 includes a pusher 30 interposed between a pair of dividers 32. The pusher 30 rides upon and is guided by a track 34. A pair of end caps 36 close either end of the track 34. The pusher 30 contains a biasing element 38 (see FIG. 2) connected to one of the end caps 36. The biasing element 38 biases the pusher 30 towards the leading edge 22 of the shelf 12. The dividers 32 and end caps 36 connect to front and rear shelf mounts 40. The shelf mounts 40 are connected to the shelf 12 using the rows 16 of apertures 18. The dividers 32 and end caps 36 connect to the shelf mounts 40 such that the alarm sounding pusher system 10 is maintained upon the shelf 12 in a generally rigid and structurally sound state.

Turning now to FIG. 2, the above advantages and benefits of the tone generation module 42 are accomplished in part by the incorporation of a contact board 44 within the alarm sounding pusher system 10. The contact board 44 is contained within the track 34. The contact board 44 is in electrical communication with the tone generation module 42. The end caps 36 maintain the contact board 44 in place within the track 34.

As will be discussed in greater detail below, the pusher 30 has a first contact and rides along the track 34 making contact with a second contact formed by the contact board 44. More specifically, the pusher 30, as it moves along the track 34, opens and closes an electrical circuit incorporating the contact board 44 and tone generation module 42. Accordingly, the first and second contacts form a sensor that senses movement of the pusher upon removal or withdrawal of retail merchandise. As will be more fully understood from the following, the sensor can take the form of various other structures not necessarily limited to first and second contacts.

In one embodiment the tone generation module 42 is operable to provide an audible tone when the circuit is in an open state. In another embodiment, the tone generation module 42 is operable to provide an audible tone when the circuit is in a closed state. In yet another embodiment, the tone generation module is operable to provide an audible tone upon detecting a change in state from open to close or from close to open of the electrical circuit. In further embodiments, the tone generation module 42 in combination with the contact board 44 and pusher 30 are operable to provide an audible tone under various other conditions.

The track 34 is an elongated member that extends between first and second ends 50, 52. The track 34 defines a pocket 54 for containment of the contact board 44. The pusher 30 can engage the contact board 44 contained within the pocket 54 through an open bottomed channel 56 of the track 34.

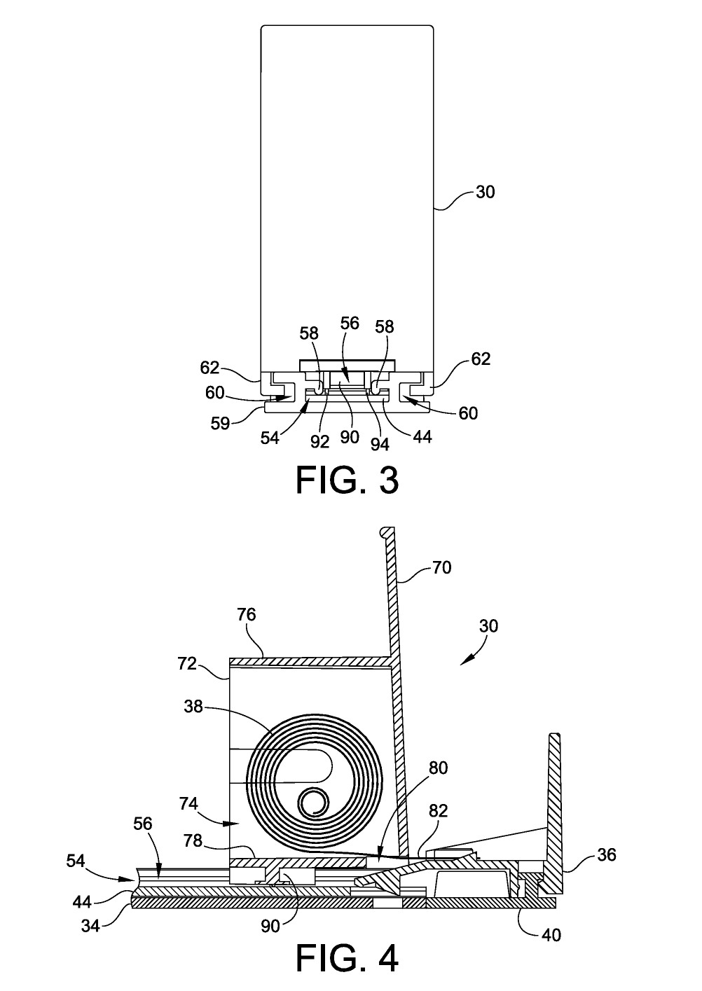

Turning now to FIG. 3, the track 34 also includes a pair of down turned flanges 58. The flanges 58 define the extremities of the open bottom channel 56 and also serve to seat the contact board 44 within the pocket 54. The track 34 has a pair of guide grooves 60 that receive inwardly extending guides 62 for aligning and guiding the pusher 30 relative to the track 34. The guides 62 are slidable within the grooves 60 of the track. It is recognized that other structures can be used to guide the pusher 30 relative to the track 34. For example, the pusher 30 and track 34 could each utilize a single guide and groove, respectively. For additional example, the guide could be part of the track 34 and the groove 60 could be part of the pusher 30.

Referring now to FIG. 4, the pusher 30 has a paddle 70 and a housing 72. As illustrated in FIG. 4 and additionally in FIG. 1, the paddle 70 makes contact with retail merchandise 14 (see FIG. 1). The housing 72 is generally a rectangular chamber having an open back 74 and extending between top and bottom walls 76, 78. The paddle 70 also forms a front of the housing 72.

The housing 72 carries the biasing element 38. In the illustrated embodiment of FIG. 4, the biasing element 38 is a coil spring. However, in other embodiments, the biasing element 38 can take the form of various other biasing elements e.g. compression springs, elastic members, etc. The bottom wall 78 of the housing 72 has an opening 80 therein for routing of an end 82 of the biasing element 38. As will be discussed in greater detail below, the end 82 of the biasing element 38 connects to one of the end caps 36. As the pusher 30 is pulled or biased away from the end cap 36, the biasing element 38 through its connection to the same end cap 36 biases the pusher 30 back toward the end cap 36.

Referring now to FIGS. 3 and 4, the pusher 30 also includes a contact structure 90 extending from a bottom of the pusher 30. The contact structure 90 carries a first contact member 92 and a second contact member 94. As will be discussed in greater detail below, the first and second contact members 92, 94 make contact with the contact board 44 to open and close a circuit with the tone generation module 42 (see FIG. 1). The contact structure 90 carrying the first and second contact members 92, 94 extends through the open bottom channel 56 into the pocket 54 to contact the contact board 44.

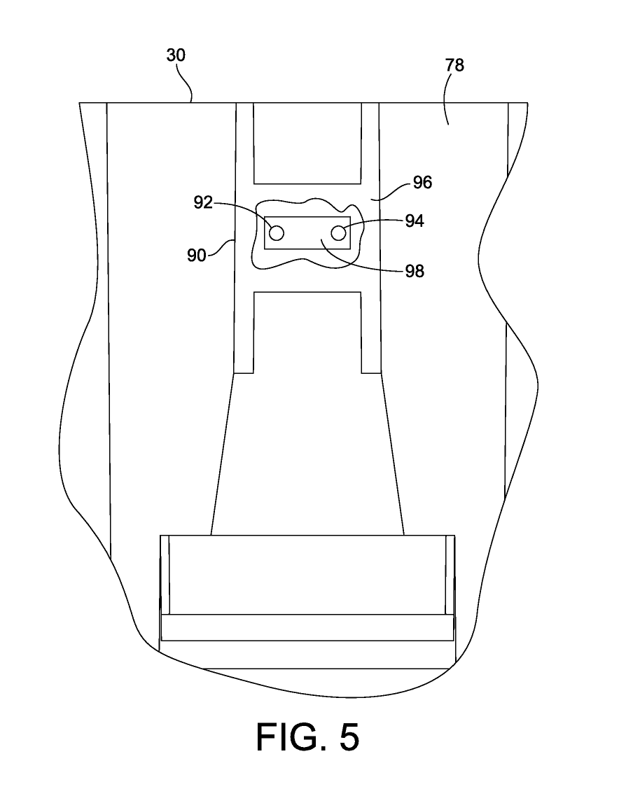

With reference to FIG. 5, the first and second contact members 92, 94 extend through a bottom surface 96 of the contact structure 90 (see also FIG. 3). The contact structure 90 also carries a union 98. The union 98 conductively joins the first and second contact members 92, 94 such that electrical current can flow into the first contact member 92, across the union 98, and out of the second contact member 94, or vice versa. As a result, the first and second contact members 92, 94 and union 98 carried by the contact structure 90 can function to complete an electrical circuit with the tone generation module 42 (see FIG. 1). The first and second contact members 92, 94 can be spring loaded to better facilitate their connection between the union 98 and contact board 44. Although illustrated as utilizing several components, the first and second contact members 92, 94 and union 98 can be formed as a one piece construction. Indeed, various other configurations of the contact structure 90 are contemplated, that will achieve the benefits disclosed herein.

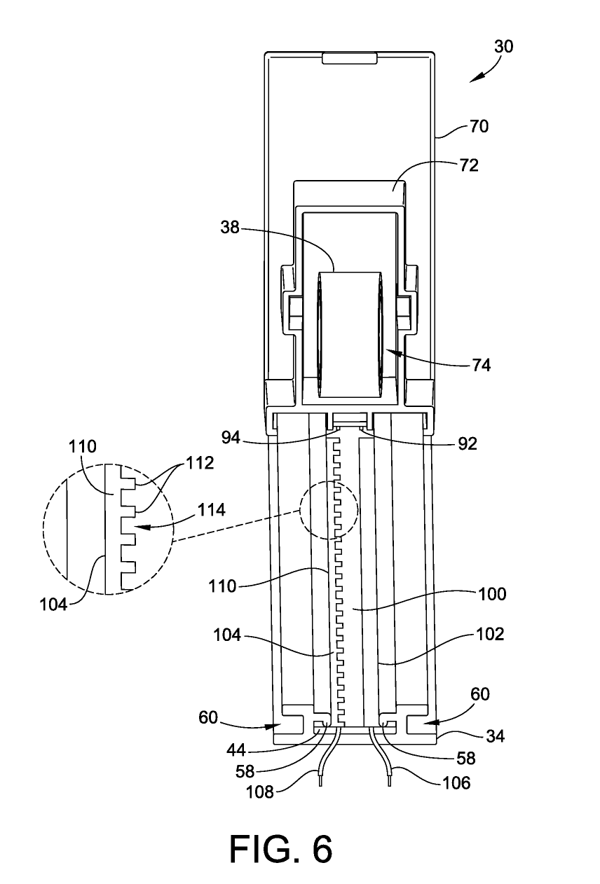

Turning now to FIG. 6, as discussed above, the contact board 44 resides within the track 34. The contact board 44 has a non-conductive board 100 that carries a first and second contact strip 102, 104. The first and second contact strips 102, 104 are electrically insulated from one another by way of the non-conductive board 100. The first contact strip 102 has a first lead wire 106 extending from an end thereof. Similarly, the second contact strip 104 has a second lead wire 108 extending from an end thereof. The lead wires 106, 108 terminate at the tone generation module 42.

The first contact member 92 is in constant contact with the first contact strip 102. However, the second contact member 94 is in intermittent contact with the second contact strip 104 as a function of the serrated design of the second contact strip 104. More specifically, the second contact strip has a base portion 110 and a plurality of equally spaced extensions 112 extending from the base portion 110. The second contact member 94 remains out of contact with the base portion 110 during operation of the alarm sounding pusher system 10.

However, the second contact member 94 will intermittently contact the extensions 112. As a result, and as will be discussed in greater detail below, electrical current will flow between the first and second contact strips 102 and 104 when the first and second contact members 92 and 94 are aligned therewith such that the second contact member 94 is in contact with one of the plurality of extensions 112 of the second contact member 104. Likewise, electrical current will not flow between the first and second contact members 102, 104 when the second contact member 94 is aligned with an opening 114 between the extensions 112 of the second contact member 104.

While the particular configuration and design of the first and second contact strips 102, 104 are illustrated, it is recognized that various other configurations are contemplated. For example, the position of the first and second contact strips 102, 104 could be reversed. For additional example, the first and second contact strips 102, 104 could possess any other shape sufficient to achieve the functionality described herein.

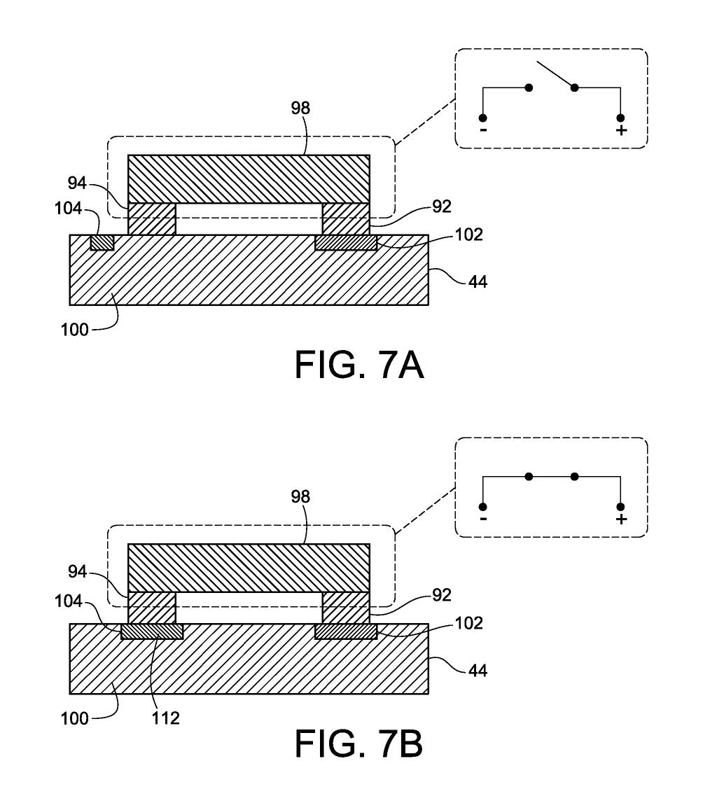

Turning now to FIGS. 7A-B, the interaction between the first and second contact members 92, 94 and the first and second contact strips 102, 104 is further illustrated. With reference to FIG. 7A, the first contact member 92 is aligned with the first contact strip 102. The second contact member 94 is within an opening 114 of the second contact strip 104, and is thus in contact with the non-conductive board 100 of the contact board 44. When this is so, current cannot flow between the first contact member 92 and second contact member 94. The result is schematically illustrated as an opened switch or contact.

Turning now to FIG. 7B, when the first contact member 92 is aligned with the first contact strip 102 and the second contact member 94 is aligned with one extension 112 of the second contact strip 104, current will flow between the first contact member 92 through the second contact member 94, and likewise therefore through the first contact strip 102 and second contact strip 104. When this is the case, the illustrated configuration is schematically represented as a closed switch or contact. It is recognized that the above description can be reversed such that current selectively flows from the second contact strip 104 through the second contact member 94 and union 98 to the first contact member 92 and first contact strip 102.

It will further be recognized that from the foregoing description and with reference to FIGS. 5, 6, 7A, 7B, that as the pusher 30 moves along the track 34, the second contact member 94 will intermittently contact extensions 112 and openings 114. Accordingly, an electrical circuit will likewise be intermittently opened and closed as the pusher 30 moves along the track 34. The intermittent opening and closing can occur multiple times when a single product is removed, or a single time, depending upon the spacing of the contact extensions 112.

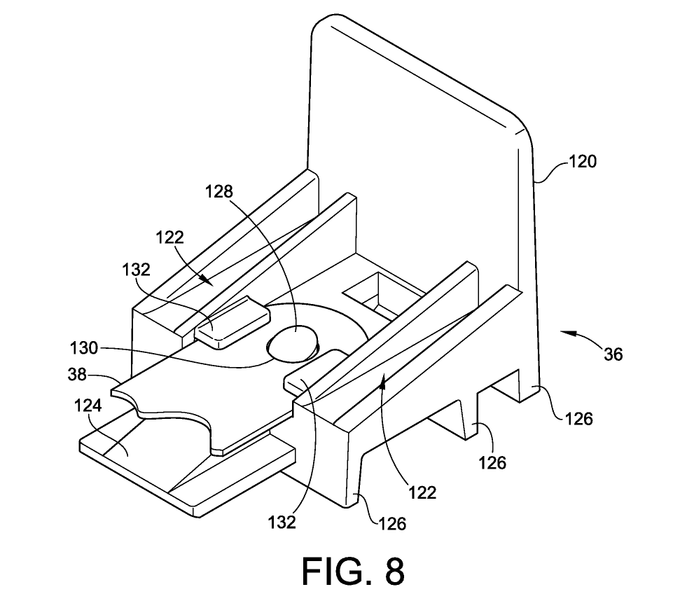

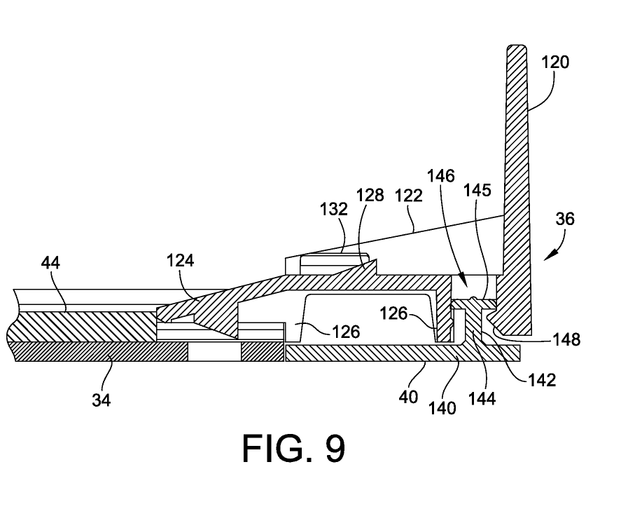

Referring back to FIG. 2, the end caps 36 maintain the contact board 44 within the pocket 54 of the track 34. As such, the contact board 44 remains fixed relative to the track 34 while the pusher 30 is free to move along the track 34 and relative to the contact board 44. The end caps 36 also function to affix the track 34 to the shelf mounts 40 (see FIG. 1). As illustrated in FIG. 2, the end caps 36 are generally symmetric such that one end cap 36 is not specific to a particular end of the track 34. With reference now to FIG. 8, the end cap 36 has a front stop 120. The front stop 120 functions as a barrier preventing retail merchandise 14 contained within the alarm sounding pusher system 10 from passing beyond the front stop 120 under the biasing action of the pusher 30 and biasing element 38. (See FIGS. 1, 2).

The end cap 36 can also incorporate ramped structures 122 to ramp retail merchandise 14 upward and away from the retail shelf 12 and towards the front stop 120. The end cap 36 also includes a tongue portion 124 that is dimensioned to fit within the pocket 54 and open bottomed channel 56 of the track 34 (see FIG. 2). The end cap 36 also has a plurality of support legs 126 vertically supporting the end cap 36. In the illustrated embodiment of FIG. 8, the end cap 36 has three support legs 126, however, more or fewer support legs 126 are contemplated.

Still referring to FIG. 8, the end cap 36 has a mounting post 128 dimensioned to receive an end 82 of the biasing element 38 and more particularly an opening 130 of the biasing element 38. The end cap 36 further includes a pair of retention flanges 132 to further facilitate the retention of the biasing element 38 once it is connected to the mounting post 128.

Turning now to FIG. 9, as stated above, the end cap 36 interlocks with the shelf mount 40 (see FIG. 1). The shelf mount 40 includes a securement portion 140 that remains in surface contact with the shelf 12 (see FIG. 1). A rail 142 extends upwardly away from the securement portion 140. The rail 142 has a vertical support portion 144 and a flange 145. The rail 142 is dimensioned to be interfit within a channel 146 of the end cap 36. A locking tab 148 projects inwardly from the channel 146 to interlock with flange portion 145 of the rail 142.

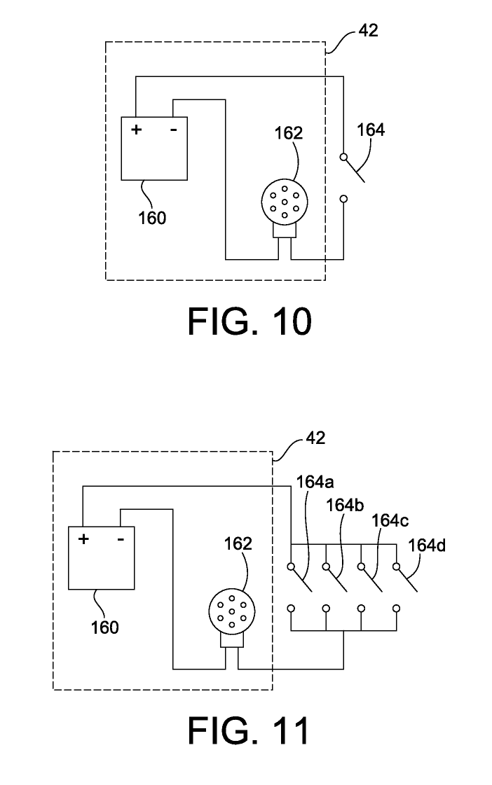

Turning now to FIGS. 10-13, various configurations of the tone generation module 42 are illustrated. In FIG. 10, the tone generation module 42 includes a power source 160 and a tone generator 162. The alarm sounding pusher system 10 is schematically illustrated in FIG. 10 as a switch 164. When the switch 164 is in an open state as described above relative to FIG. 7A, current will not flow from the power source 160 to the tone generator 162 and therefore no audible tone will be emitted by the tone generator 162. However, when the switch 164 is in a closed position as discussed above with reference to FIG. 7B, current will flow from the power source 160 through the tone generator 162 and an audible tone will be generated thereby. As a result, the switch 164 acts as a sensor for the detection of current.

Turning now to FIG. 11, the control module 42 is operable to connect with multiple alarm sounding pusher systems 10 illustrated in FIG. 11 schematically as switches 164a-d. It will be recognized from examination of FIG. 11 that when any one of switches 164a-d are closed, an audible tone will generate from the tone generator 162 by way of electrical current flowing from the power source 160 to the tone generator 162. It will also be recognized that current will not flow when all of switches 164a-d are in an open state and thus no audible tone will generate from the tone generator 162.

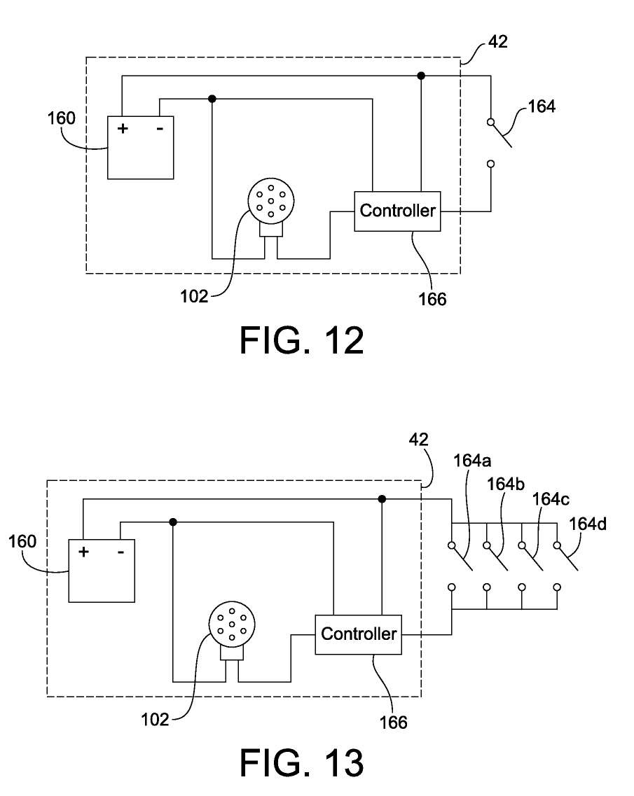

Turning now to FIG. 12, the tone generation module 42 can also include a controller 166. The controller 166 is operable to detect when the switch 164 transitions from an open to a closed state or from a closed to an open state by detecting the presence or absence of current. The controller 166 can be configured to allow power to be temporarily supplied to the tone generator 162 upon the detection of a change of state of the switch 164, i.e the electrical circuit formed between the pusher 30 and the contact board 44.

In certain embodiments, the controller 166 can be programmed to count a number of changes of state of the switch 164 before allowing power to be supplied to the tone generator 162. Additionally, the controller 166 can be programmed with a predetermined time period for the duration of power to be supplied to the tone generator 162 so as to govern the duration of the audible tone. With reference to FIG. 13, a similar configuration incorporating a controller 166 can also function with multiple alarm sounding pusher systems represented symmetrically by switches 164a-d similar to that as described above with respect to FIG. 11.

Despite the configuration selected, the tone generation module 42 is operable to provide an audible tone generally any time one or more items of retail merchandise 14 is removed, however, such functionality is not limiting on the invention. Indeed, as discussed above, the tone generation module 42 can incorporate a controller 145 such that various settings and configurations of tone generation are contemplated. As a result, various thresholds can be established to define the timing and manner of tone generation.

The audible tone provided by the tone generator 160 can take numerous forms. For example, the tone can be a continuous tone for a predetermined period of time, or discontinuous such that several tones are provided in rapid succession. For example, the tone generator may play a tone for 1-5 seconds and then automatically stop. Moreover, the tone generator 160 can play a pre-recorded message. Additionally, the tone generator 160 can play a tone that stays at a predetermined volume, or that escalates to a higher volume.

Additionally, the change of state of the electrical circuit formed by the pusher 30 and the contact board 44 can be used for other purposes not necessarily associated with playing the audible tone alone. For example, in other embodiments, when the controller 166 detects a change of state in the electrical circuit, it can also provide a visual indication as well as an audible tone. The visual indication may be, for example, an illumination of an LED light. Additionally, the controller 166 can be networked with a retail store's security camera system and control the operation of certain cameras to focus on the pusher system upon a change of state of the electrical circuit.

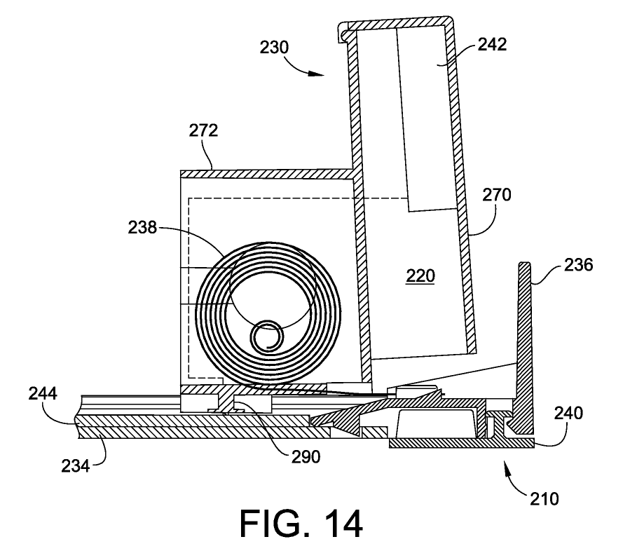

Turning now to FIG. 14, another embodiment of an alarm sounding retail display system embodied in an alarm sounding pusher system 210 is illustrated. In this embodiment, the tone generation module 242 is carried by the pusher 230 within a chamber 220 of the paddle 270 of the pusher 230. The alarm sounding pusher system 210 illustrated in FIG. 14 functions in a similar manner as that discussed above. More particularly, the alarm sounding pusher system 210 has a pusher 230 that contains a biasing element 238 within a housing 272. The biasing element 238 is connected to an end cap 236. The biasing element 238 pulls the pusher 230 towards the end cap 236. The pusher rides along and is guided by a track 234 as it is biased forward by the biasing element 238. The track 234 contains a contact board 244. The contact board 244 functions in a similar manner as discussed above with respect to contact board 44 in that it completes a circuit between the contact board 244, contact structure 290 and tone generation module 242.

In the illustrated embodiment, the tone generation module 242 is specific to the alarm sounding pusher system 210. However, in other embodiments, it is contemplated that one alarm sounding pusher system 210 can contain a tone generation module 242 and other alarm sounding pusher systems that otherwise do not contain a tone generation module 242 can be interconnected with the alarm sounding pusher system 210 to perform the functionality as described herein.

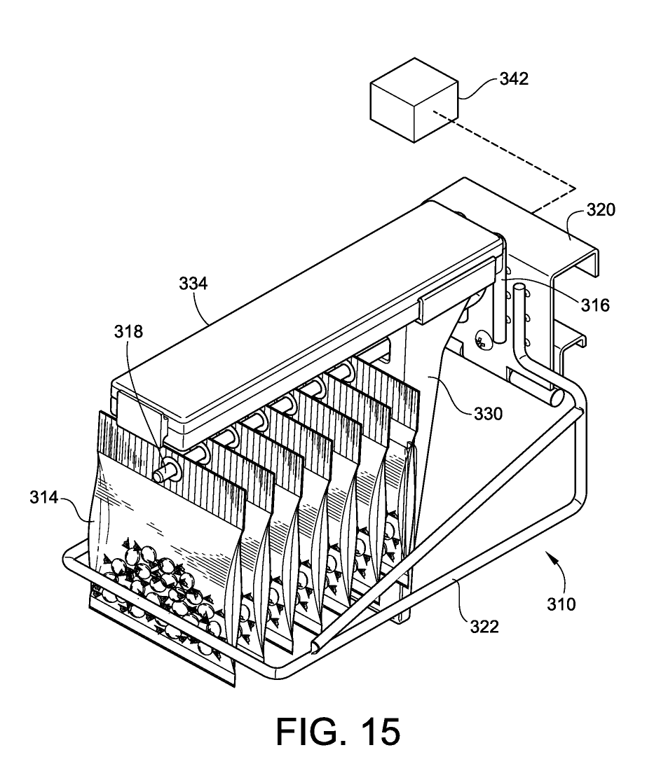

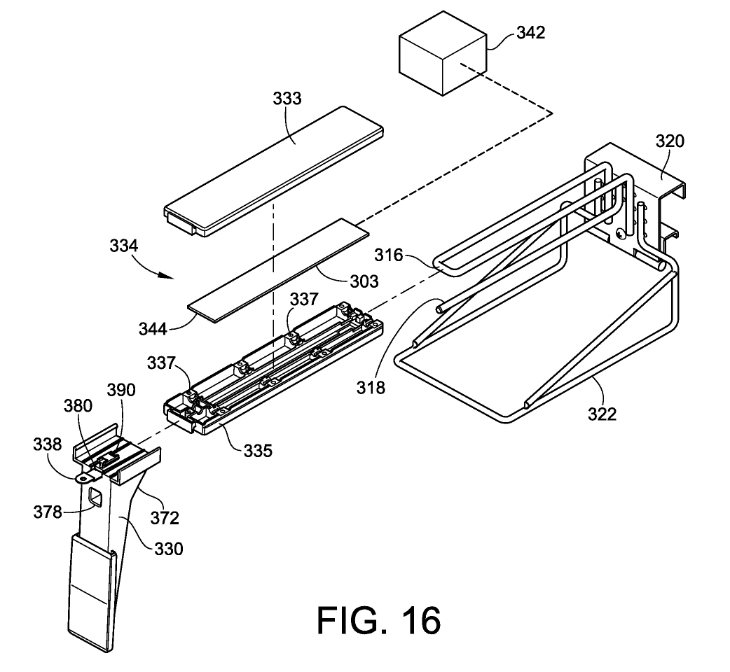

Turning now to FIG. 15, another embodiment of an alarm sounding retail display system embodied in an alarm sounding pusher system 310 is illustrated. In this embodiment, a pusher 330 and track 334 are integrated with a retail hook 318 for hanging retail merchandise 314 therefrom. In a similar manner as discussed above, as the front most item of retail merchandise 314 is removed from the alarm sounding pusher system 310, the next item of retail merchandise 314 is biased forward by the pusher 330. More particularly, the pusher 330 is biased forward by a biasing element 338 contained within the pusher 330 (see FIG. 16).

With reference to FIG. 16, the track 334 is supported by a support frame 316 and is in electrical communication with a tone generation module 342. A retention frame 322 is also provided to retain the retail merchandise 314 on the hook 318 such that the pusher 330 cannot bias all of the retail merchandise 314 off of the hook 318. The retention frame 322 also prevents retail merchandise 314 (see FIG. 16) from being removed in groups during a retail theft scenario referred to as “sweeping”.

The support frame 316, retail hook 318 and retention frame 322 are all fixedly attached to a mounting bracket 320. The mounting bracket 320 in turn is configured to mount to a retail structure such as a structure incorporating rigid wires, or any other structure sufficient to support the pusher system 310. Indeed, the mounting bracket 320 is not meant to limit the pusher system 310 to any particular environment. Still referring to FIG. 16, the track 334 is a split design having a first half 333 and a second half 335. The contact board 344 is contained between the first and second halves 333, 335. The first and second halves 333, 335 connect with one another via connections structures 337. The contact board 344 is contained within the track 334 such that a contact structure 390 of the pusher 330 can contact the contact board 344 in a similar manner as discussed above with respect to FIGS. 2-6.

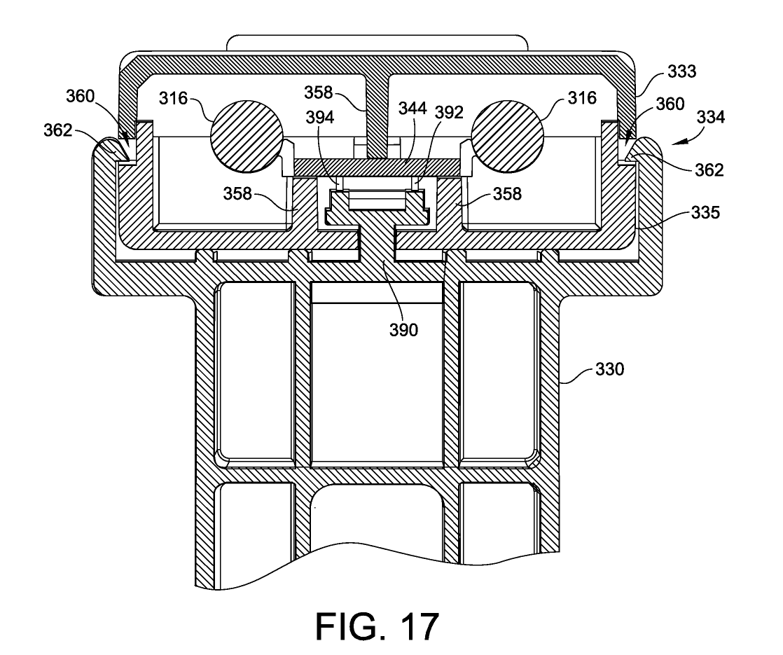

More particularly and with reference now to FIG. 17, the contact structure 390 of the pusher 330 has a first contact member 392 and a second contact member 394. The first and second contact members 392, 394 contact first and second contact strips 302, 304 of the contact board 344 (see FIG. 19). The contact board 344 is maintained within the track 334 between the first and second halves 333, 335 thereof by contact board support structures 358. When the first and second halves 333, 335 of the track 334 are joined, the support structures 358 maintain the contact board 344 generally within the center of the track 334. Also when joined, the track 334 has a pair of guide grooves 360 dimensioned to receive inwardly extending guides 362 of the pusher 330.

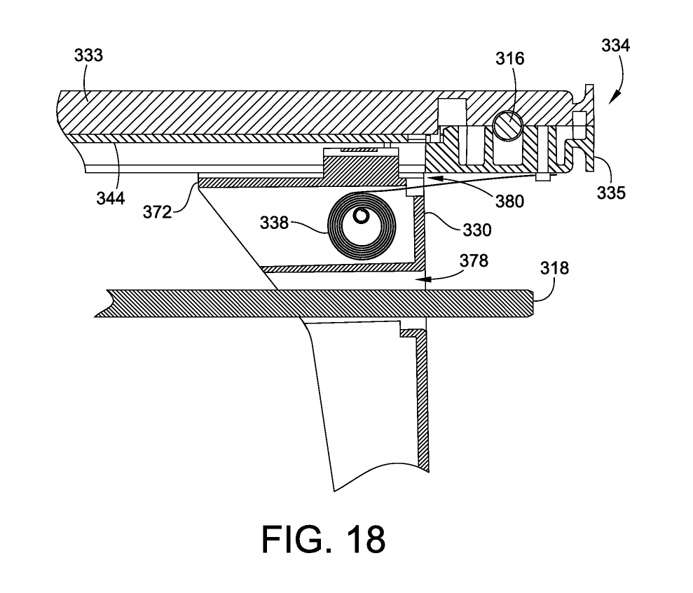

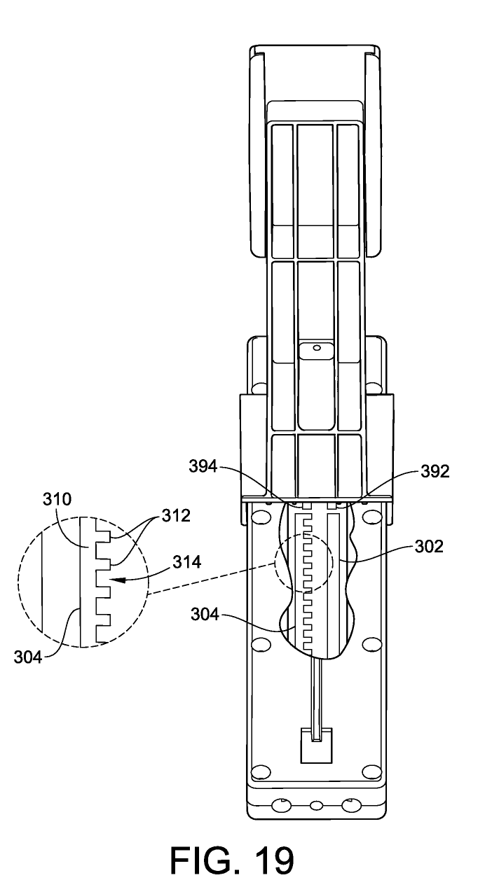

Turning now to FIG. 18, the pusher 330 carries the biasing element 338 within a housing 372. The biasing element 338 extends through an opening 380 of the pusher 330 and mounts to the bottom half 335 of the track 334. As the pusher 330 is pulled away from the leading end of the track 334, the biasing element 338 acts to bias the pusher back toward the leading end of the track 334. The pusher 330 further has an opening 378 to allow the retail hook 318 to freely pass therethrough. It will be recognized from examination of FIG. 18 that as the pusher 330 is biased forward by the biasing element 338, it moves relative to the contact board 344, retail hook 318, and track 334.

With reference now to FIG. 19, as the pusher 330 moves forward, the second contact member 394 is brought into intermittent contact with extensions 312 of the second contact member 304. As this occurs, a circuit formed with the contact board 344 and the tone generation module 342 (see FIG. 16) is likewise intermittently opened and closed. The tone generation module 342 will in turn provide an audible tone intermittently or under the operation of a controller also as described above.

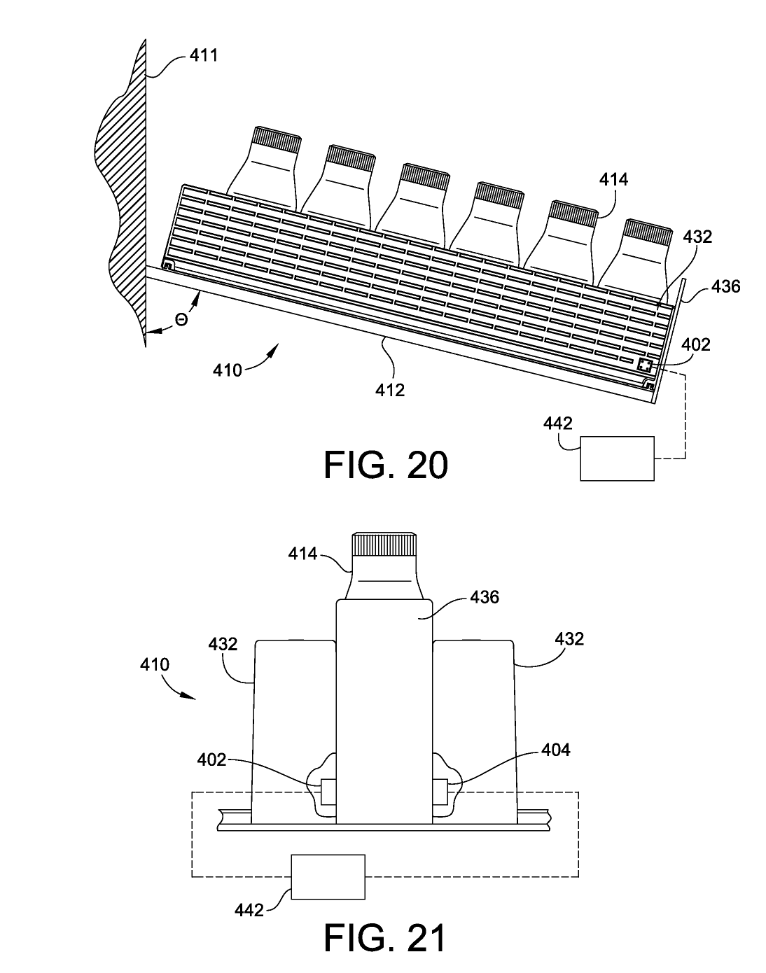

Turning now to FIGS. 20 and 21, another embodiment of an alarm sounding retail display system embodied as an alarm sounding gravity fed system 410 is illustrated. In the illustrated embodiment, a row of retail merchandise 414 is situated on a retail shelf 412 and contained between parallel dividers 432. As the leading item of merchandise 414 is removed, the row moves forward under gravity as a result of the angle θ formed between the shelf 412 and a support structure 411 supporting the shelf. The row moves forward until the next item 414, now the leading item 414, engages a front stop 436.

The gravity fed system 410 also includes a light source 402 and a light detector 404 defining a sensor. The light detector 404 is aligned with the light source 402 such that the leading item of retail merchandise 414 interrupts a beam of light emitted from the light source 402. When the leading item of merchandise is removed, the beam of light is detected by the light detector 404. Once detected, a signal is sent to a tone generation module 442, and an audible tone is generated in accordance with the description herein.

It will be recognized that in other embodiments, a light detector 404 could be used without an additional light source 402. In such an embodiment, the light detector 404 detects a change in lighting conditions in proximity to the detector 404 when the leading item of merchandise 414 is removed from the system 410.

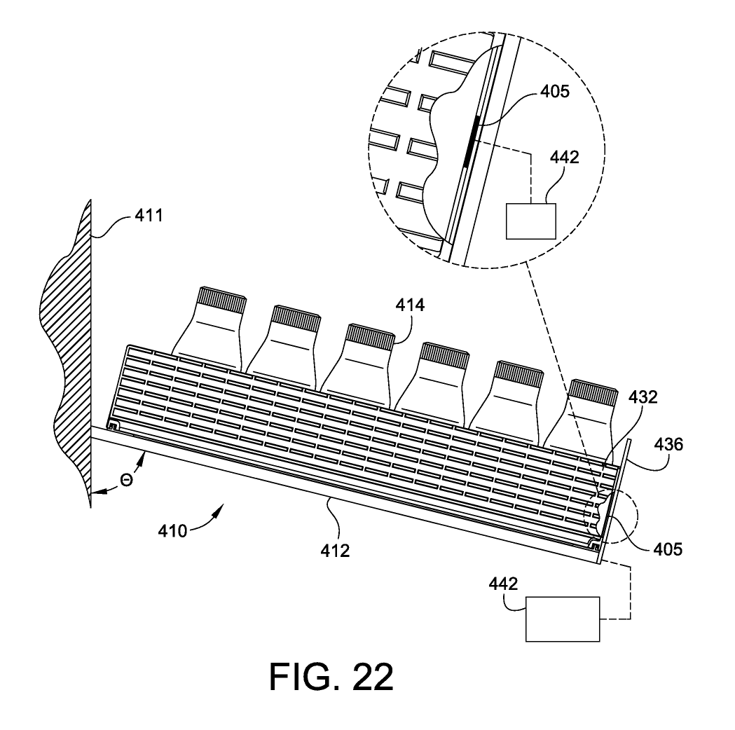

Turning now to FIG. 22, in an alternative embodiment, a touch and/or a proximity sensor 405 can replace or supplement the light source 402 and light detector 404 configuration of FIGS. 20 and 21. In this embodiment, the leading item of retail merchandise 414 is in contact or proximity to the sensor 405. Once removed, the sensor sends a signal to the tone generation module 442, and an audible tone is generated in accordance with the description herein.

It will be recognized from the foregoing that certain embodiments of the invention do not contemplate the necessity of an additional product actuation mechanism in their respective operations. More specifically, product need only be manually added and/or removed to face more product forward, and to generate an audible tone. However, other embodiments can incorporate additional actuation systems. It is also contemplated that in certain embodiments, the system will provide an audible tone only after an item is actually removed, causing the remaining merchandise to move forward. However, in other embodiments, the system can provide an audible tone when an item is only partially removed, using sensors, controllers, and/or combinations thereof.

Turning now to embodiments of active systems introduced above, and with reference to FIG. 23, a plurality of retail display systems 510a-c are illustrated connected to a terminal 508 generally forming a control module. The terminal 508 can be a typical computer, or some other form of an input/output device, such as a handheld device. As will be explained in greater detail below, the terminal 508 can implement software that provides a variety of additional inventory management and loss prevention functionality. As a result, the word “terminal” is not meant to limit the control module to any specific structure, but instead is used to broadly categorize a control module having input and output capability to implement the functionality described herein.

As will be more fully explained by the following, the terminal 508 is in two-way communication with the retail display systems 510a-510c and allows a user to input and receive information related to inventory management and security. For example, the terminal 508 can alert a security system 544 such as a security camera to focus upon a particular retail display system 510a-c in the event of a potential retail theft. The terminal 508 can also alert store personnel via a wireless device 546 in wireless communication with the terminal 508 of a potential retail theft.

Additionally, the terminal 508 can implement control logic and software to provide inventory information such as the quantity of merchandise contained in a particular retail display system 508. This inventory information may be provided locally at the terminal 508, or elsewhere, such as on another device in communication with the terminal 508, such as the wireless device 546 illustrated.

The terminal 508 may function automatically or manually with the retail display systems 510a-c. More specifically, the terminal 508 can be automatically or manually calibrated to recognize the addition and removal of retail merchandise from the retail display systems 510a-c. When the terminal 508 is configured for automatic operation, i.e. “self-learning” mode, it will automatically “learn” the dimensions of a particular type of retail merchandise carried by a retail display system 510a-c by recognizing a repeating value of a sensed parameter of the retail display system associated with the addition and/or removal of one or more individual units of retail merchandise. As discussed above, the retail display systems 510a-c may incorporate a variety of sensors, e.g. light, proximity, electrical signal, magnetic, and touch sensors to provide the sensed parameter. The values of these sensed parameters can be monitored and manipulated by the control logic implemented by the terminal 508.

The terminal 508 is operable to recognize that a particular type of retail merchandise causes a specific and particular value in the sensed parameter when an individual unit of that type of merchandise is added or removed. For a non-limiting example, when using a contact board 44 as described above with respect to FIG. 6, the sensor may sense four successive occurrences of the first contact member 92 aligning with an extension 112 of the first contact strip 102 when an individual unit of retail merchandise is added or removed causing the pusher 30 to move relative to the contact board 44.

The terminal 508 is then operable to associate a quantity of one item of retail merchandise with the four successive occurrences. In other words, the terminal 508 is then operable to self learn by associating a sensed value of the parameter, in this case the intermittent electrical contact of the first contact member 92 and the extensions 112, with a particular quantity of merchandise. The terminal 508 can be configured to self learn after a single occurrence of the sensed parameter, or after multiple occurrences. From the above example, the repeating value would be multiple separate sets of four contacts of the first contact member 92 and the extensions 112. The terminal 508 can implement logic to understand these repeating values to be characteristic of consumer behavior for a given product.

Additionally, and when configured to function automatically, the terminal 508 is also operable to automatically respond to changes in the repeating value of the sensed parameter. Using the previous example, the terminal 508 is operable to recognize a change from four successive occurrences to six successive occurrences of the first contact member 92 aligning with an extension 112 of the first contact strip 102 when an individual unit of retail merchandise having different dimensions than the prior type of retail merchandise is added or removed. The terminal 508 is then operable to associate a quantity of one item of retail merchandise with the six successive occurrences. The terminal 508 may make the above association after a single occurrence, or after multiple occurrences of a repeating value of the sensed parameter as discussed previously.

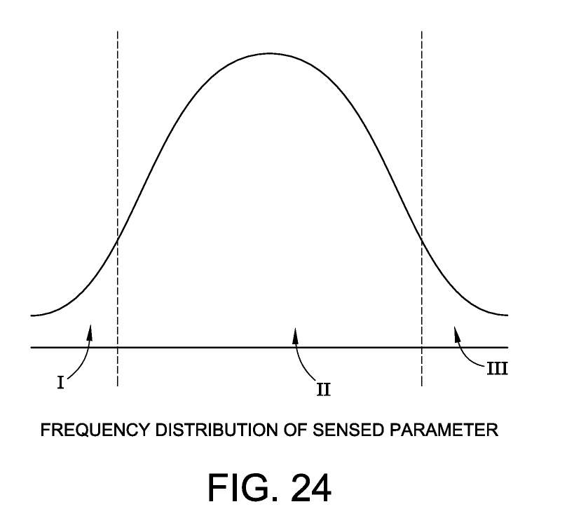

Also when configured to function automatically, i.e. self learn, the terminal 508 may establish a frequency distribution of the typical value of the sensed parameter as illustrated in FIG. 24. The terminal 508 can implement logic that will draw a distinction between values of the sensed parameter that are normal, i.e. in region II, or values that are abnormal, i.e. in regions I and III. By establishing this range, the terminal 508 is able to recognize minor aberrations in the sensed parameter for a particular type of merchandise caused by misshapen packaging or other minor anomalies.

Using the example above, the terminal may establish a distribution of the sensed parameter as any value of the sensed parameter between four and sixteen successive contacts of the first contact member 92 with an extension 112 of the contact strip. Any value of the sensed parameter outside of this range can be considered as indicative of a potential retail theft, and/or a system failure. With continued reference to FIG. 24, instances of less than four contacts could correlate to less than the thirtieth percentile, while instances of greater than sixteen contacts could correlate to greater than the seventieth percentile.

The terminal 508 may also be configured to function manually, i.e. “manual-learning” mode. More particularly, the terminal 508 may be configured to learn the specific dimensions of a particular type of retail merchandise when a user deliberately initiates a retail merchandise learning mode. Once initiated, the user can add or subtract one or more items of retail merchandise from the retail display system 510a-c. After adding or subtracting, the user simply defines the quantity of items just added or subtracted using the terminal 508. The terminal 508 then associates the quantity with the particular sensed parameter associated with the corresponding addition or subtraction. The user then exits the retail merchandise learning mode, and the retail display system is ready for normal operation.

Whatever mode used, there are several advantages achieved by incorporating the terminal 508. As one example, the terminal 508 can monitor the amount of retail merchandise carried by the retail display systems 510a-c. When the retail merchandise is depleted or about to be depleted, the terminal 508 can provide an indication to store personnel to restock the retail display system 510a-c.

Additionally or in the alternative, the terminal 508 can be configured to automatically reorder retail merchandise once a predetermined low quantity threshold is passed. More generally, the terminal 508 can provide an indication of the amount of retail merchandise carried by a particular retail display system 510a-c. For example, the terminal 508 could provide a visual indication such as a number of items remaining, or display a gauge. The terminal 508 could also provide an audible indication as discussed above with respect to the tone generation module.

One particular advantage relative to loss prevention is the ability to automatically or manually define a threshold quantity of removal over a given time period using the terminal 508. As will be more fully understood from the following, the time period may dependent on the type of retail merchandise carried in the particular retail display system 510a-c. More specifically, the time period of the threshold may be greater for certain high traffic items, i.e. items frequently removed by a consumer, and lesser for low traffic items, i.e. items less frequently removed by a consumer.

The threshold quantity can be defined so as to identify an instance of “sweeping” of multiple items of retail merchandise that is uncharacteristic of ordinary consumer behavior and indicative of a potential retail theft. Using the example above, if the repeating value of the sensed parameter is ordinarily four successive contacts of the first contact member 92 with an extension 112 of the first contact strip 102 over thirty seconds, the threshold could be defined as sixteen successive contacts in thirty seconds, corresponding to the removal of four items of retail merchandise in rapid succession, indicating that the product has been swept.

When the threshold is met or exceeded, the terminal 508 could alert security personnel or activate other security measures. For example, the terminal 508 could signal a security system 544 such as a security camera to focus on the retail display system 510a-c that has experienced a threshold removal. For another example, the terminal 508 could signal the retail display system 510a-c to provide an audible or visual alert using an indication device 547.

The threshold can also be defined manually. More particularly, a user can manually define the threshold using the terminal 508. Using the above example, a user can manually define the threshold as sixteen successive contacts of the first contact member 92 and the extensions 112 of the contact strip 102 over thirty seconds.

It will be recognized from the above that one advantage of the terminal 508 as described herein is that there is no need to manually measure the physical dimensions of an item of retail merchandise. Indeed, the terminal 508 is operable to learn, automatically or manually, a product's dimensions by using a sensed parameter related to the movement of retail merchandise within the retail display system 510a-c. Accordingly, there is no need to define, for example, a movement of 8 inches corresponds to two items of retail merchandise based on a manually measured product width of 4 inches per item.

Turning now to FIGS. 6, 23, and 25, an exemplary embodiment of self learning control logic is illustrated. It will be recognized that the illustrated embodiment is only one example of logic that could be implemented to self learn. When initiated at step 602, the terminal 508 will begin monitoring a sensed parameter, e.g. contact of the first contact member 92 with the extension 112 at step 604. The terminal 508 will then determine a repeating value of the sensed parameter at step 606, e.g. successive instances of four contacts of the first contact member 92 and the extensions 112. At step 608, the terminal will then associate a quantity with the repeating value developed in step 606. For example, the terminal 508 may associate a quantity of one with the repeating value of four successive contacts of the contact member 92 with the extensions 112. The terminal 508 is also operable to incorporate frequency distribution analysis at step 608 as described above with respect to FIG. 24.

At step 610, the terminal 508 is then operable to assign a threshold of removal to the repeating value developed at step 606. For example, the terminal 508 may assign a threshold of removal of four successive instances of four contacts of the first contact member 92 with the extensions 112 occurring in thirty seconds.

The terminal 508 will then continue to monitor the parameter at step 612. More particularly, the terminal 508 will monitor the parameter for an event that causes the threshold to be exceeded or for there to be a change in the repeating value. If the terminal 508 detects that the threshold has been exceeded at step 614, it will employ further security measures at step 616. These security measures may include, but are not limited to, providing a visual and/or audible indication locally at the terminal 508 or in proximity to the retail display systems 510a-c using the hub 543, the tone generation modules 542a-c, the wireless device 546, the indication device 547, or any combination thereof. The indication provided may be sufficiently apparent to notify nearby security personnel but not overbearing to annoy other customers.

Also while monitoring the parameter at step 612, the terminal 508 is operable to recognize a change in the repeating value at step 618 evidencing a change in the type of merchandise carried by a particular retail display system 510a-c. When this occurs, the terminal 508 will repeat steps 606-612 to establish a new repeating value, associate a quantity therewith, and establish a new threshold of removal.

Turning now to FIGS. 6, 23, and 26, an exemplary embodiment of manual learning control logic is illustrated. It will be recognized that the illustrated embodiment is only one example of logic that could be implemented to manually learn. To begin, a user deliberately enters a manual learning mode at step 622. Once entered, the user manually loads one or more items of merchandise to a particular retail display system 510a-c.

As the item(s) are loaded, the terminal 508 is operable to detect a sensed parameter associated with the loading at step 626. The user then defines the quantity of retail merchandise added at step 628 to be associated with the sensed parameter. For example, the user could add one item of retail merchandise at step 624. This addition could correspond to four successive contacts of the first contact member 92 with the extensions 112. The user could then define the above as the typical sensed parameter for the addition or removal of one unit of retail merchandise carried by the retail display system 510a-c at step 628.

The user can then enter a threshold of removal at step 630. The threshold can be defined in terms of an amount of retail merchandise removed during a base time period, as discussed above. Once steps 628 and 630 are completed, the user then manually exits the learning mode at step 632. The terminal 508 has then been calibrated, and is ready to monitor the sensed parameter at step 634. The terminal 508 will continue to monitor the parameter until the threshold has been exceeded at step 636. Once exceeded, the terminal will then employ security measures at step 638, similar to that discussed above with respect to the self learning mode.

Referring back to FIG. 23, the retail display systems 510a-c may connect to terminal 508 via wiring or wirelessly using a transmitter and receiver arrangement. Additionally, a networked grouping of multiple retail display systems 510a-c may commonly connect to a hub 543. The hub 543 may provide a transmitter for communication with a receiver of the terminal 508, or be directly wired to the terminal 508. Accordingly, the hub 543 can enable the use of a single terminal 508 forming the control module as described above to control multiple retail display systems 510a-c throughout a retail establishment.

Moreover, the hub 543 may incorporate a tone generation module as described above to locally provide an audible tone in proximity to the networked grouping of retail display systems 510a-c. In addition or in the alternative, each retail display system 510a-c may include a stand alone tone generation module 542a-c as illustrated. The hub 543 and/or the tone generation modules 542a-c may mount to a retail display structure 12 (see FIG. 1) in proximity to the retail display systems 510a-c.

As described herein, embodiments of the retail display system embodied as an alarm sounding pusher system provide an audible tone via a tone generation module upon movement of a pusher relative to a track. By providing this audible tone, a would be shoplifter is deterred due to an impression of enhanced security because of the audible tone. Moreover, the audible tone functions to alert store employees in proximity to the alarm sounding pusher system that merchandise has been replaced or removed therefrom. Other embodiments provide more advance inventory monitoring and loss prevention by the incorporation of a control module.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for monitoring inventory levels of retail merchandise contained in a self facing retail display system, comprising the steps of:
sensing a parameter associated with a movement of the retail merchandise contained within the self facing retail display system using a sensor; and
determining a repeating value of the parameter for a selected retail product based upon said sensing during placement or removal of one or more individual units of retail merchandise from the self facing retail display system.

2. The method of claim 1 further comprising the step of associating a quantity of retail merchandise with the repeating value using a control module operably connected to the sensor so that each repeating value sensed is an indication that one or more units of retail merchandise has been added or removed.

3. The method of claim 2 comprising the step of determining a starting total quantity of retail merchandise carried by the self facing retail display system by loading individual units of retail merchandise to an empty retail display system thereby causing a value of the parameter to be sensed with each successive addition of each individual unit of retail merchandise, the control module operable to determine the starting total quantity by summing a number of occurrences of the value of the parameter corresponding to the total number of individual units added.

4. The method of claim 3 further comprising the step of calculating a change in quantity from the starting total quantity of retail merchandise using the control module by incrementally adding or subtracting sensed occurrences of the repeating value caused by the addition or removal of retail merchandise from the retail display system.

5. The method of claim 4 further comprising the step of establishing a threshold for the change in quantity using the control module and providing an indication that the threshold for the change in quantity has been exceeded using an indication device, the threshold of change for use in inventory management or indicating a potential retail theft.

6. The method of claim 2 further comprising the step of recognizing a change in the repeating value from a first repeating value to a second repeating value, thereby indicating that retail merchandise of a different size is now carried by the retail display system, the step of recognizing further comprising associating a quantity of merchandise with the second repeating value.

7. The method of claim 2 further comprising the step of identifying aberrations in the repeating value from a normal repeating value caused by irregularly shaped or damaged retail merchandise.

8. The method of claim 7 further comprising excluding the aberrations from the step of associating.

9. The method of claim 2 wherein the steps of sensing, determining, and associating occur automatically and without intervention from a user.

10. The method of claim 2 wherein the steps of sensing, determining, and associating are manually initiated by a user during a retail merchandise learning mode of the control module.

11. The method of claim 1 wherein the sensed parameter is an electrical signal caused by the intermittent alignment of a first and a second electrical contact of the retail display system.

12. The method of claim 1 wherein the sensed parameter is a duration of time between successive occurrences of the parameter.

13. A method for monitoring inventory levels of retail merchandise contained in a self facing retail display system, comprising the steps of:
manually initiating a retail merchandise learning mode of a control module;
changing an amount of retail merchandise carried by the retail display system by either adding or subtracting one or more individual units of retail merchandise; and
sensing a parameter associated with the change of the amount of retail merchandise using a sensor.

14. The method of claim 13 further comprising the steps of:
associating a quantity of retail merchandise with the value of the parameter sensed using the control module; and
exiting the retail merchandise learning mode.

15. The method of claim 14 further comprising the step of determining a total quantity of merchandise carried by the self facing retail display system by adding or subtracting incremental sensed occurrences of the parameter caused by the addition or subtraction one or more individual units of retail merchandise to the retail display system.

16. The method of claim 15 further comprising the step of providing an indication of the total quantity of retail merchandise present in the retail display system using an indication device.

17. The method of claim 16 further comprising the step of establishing a threshold of change in the total quantity using the control module and providing an indication that the threshold of change in the total quantity has been exceeded, the threshold of change corresponding to at least one of the addition or removal of one or more units of retail merchandise for use in monitoring inventory or indicating a potential retail theft.

18. The method of claim 14 further comprising the steps of:
manually reinitiating the retail merchandise learning mode;
changing an amount of retail merchandise carried by the retail display system by either adding or subtracting one or more individual units of retail merchandise;
sensing a parameter associated with the change of the amount of retail merchandise;
associating a quantity of retail merchandise with the value of the parameter sensed; and
manually exiting again the retail merchandise learning mode.

19. A method for monitoring inventory levels of retail merchandise contained in a self facing retail display system, comprising the steps of:
sensing a parameter associated with the addition or removal of one or more selected items of retail merchandise using a sensor;
automatically associating a quantity of merchandise with a value of the parameter based on said sensing using a control module.

20. The method of claim 19 further comprising the step of determining a total quantity of retail merchandise carried by the self facing retail display system based on the associated quantity.

21. The method of claim 20 further comprising the step of establishing a threshold of change in the total quantity and providing an indication using an indication device that the threshold of change has been exceeded for use in inventory monitoring and indicating a potential retail theft.

22. The method of claim 19 further comprising the step of recognizing a change in a repeating value of the parameter thereby indicating that retail merchandise having different dimensions from retail merchandise previously carried is now carried by the retail display system, the step of recognizing further comprising associating a quantity with the retail merchandise having different dimensions from the retail merchandise previously carried.

23. The method of claim 19 further comprising the step of automatically recognizing aberrations in the value of the sensed parameter, and excluding the aberrations from the step of automatically correlating.

24. The method of claim 19 wherein the sensed parameter is an electrical signal caused by the intermittent alignment of a first and a second electrical contact of the retail display system.

25. The method of claim 19 wherein the sensed parameter is a duration of time between successive occurrences of the parameter.
